(19) United States
(12) Patent Application Publication
(10) Pub. No.: US 2016/0078398 A1
(43) Pub. Date: Mar. 17, 2016

(54) METHODS AND APPARATUS TO CATEGORIZE ITEMS

(71) Applicant: The Nielsen Company (US), LLC, Schaumburg, IL (US)

(72) Inventor: Qiujing Lu, Shanghai (CN)

(21) Appl. No.: 14/487,720

(22) Filed: Sep. 16, 2014

(51) Int. Cl. G06Q 10/08; G06F 17/28; G06F 17/30

(52) U.S. Cl. CPC G06Q 10/087; G06F 17/30342; G06F 17/28

(57) ABSTRACT

Methods and apparatus are disclosed to categorize items. A disclosed example method involves converting a natural language product description associated with a transaction record that does not include indexable identifiers to create input data comprising product descriptors. The method also involves generating a first confidence level associated with a first candidate category based on ones of the product descriptors having a first weighted value associated with the first candidate category. The example method also includes generating a second confidence level associated with a second candidate category based on ones of the product descriptors having a second weighted value associated with the second candidate category, and assigning the product to one of the first or second candidate categories based on a difference between the first and second confidence levels.

### FIELD OF THE DISCLOSURE

This disclosure relates generally to market research, and, more particularly, to methods and apparatus to categorize items.

### BACKGROUND

In recent years, retailers, marketers, and manufacturers have tried to measure and/or analyze the products being purchased through both traditional brick-and-mortar stores and e-commerce websites. The collected data and/or analysis is used, for example, to develop marketing plans, and/or promotion plans. The metrics have also been used to plan product features, and/or plan store layouts.

### BRIEF DESCRIPTION OF THE DRAWINGS

FIG. 1 illustrates an example system constructed in accordance with the teachings of this disclosure to categorize items.

FIG. 2 illustrates an example data structure to associate descriptors with categories and/or weighted values.

FIG. 3 illustrates an example data structure to associate stock keeping units (SKUs) with brands, SKU descriptors, packaging information and/or other SKU information (e.g., price, flavor information, etc.).

FIG. 4 illustrates an example implementation of the input parser of FIG. 1 to receive raw input data and generate standardized input data.

FIG. 5 illustrates an example implementation of the product categorizer of FIG. 1 to process standardized input data and categorize products using information received from the transaction processors.

FIG. 6 illustrates an example implementation of the SKU categorizer of FIG. 1 to process standardized input data and to predict SKUs for categorized items.

FIG. 7 is a flow diagram representative of example machine readable instructions that may be executed to implement the example product categorizer of FIG. 1 and/or to categorize products.

FIG. 8 is a flow diagram representative of example machine readable instructions that may be executed to implement the example input parser of FIGS. 1 and 2 and/or to process raw input data into standardized input data.

FIG. 9 is a flow diagram representative of example machine readable instructions that may be executed to implement the example product categorizer of FIGS. 1 and 4 and/or to categorize items based on transaction record(s) received and/or retrieved from a transaction processor.

FIG. 10 is a flow diagram representative of example machine readable instructions that may be executed to implement the example SKU categorizer of FIGS. 1 and 5 and/or to an SKU for a categorized product.

FIG. 11 is a flow diagram representative of example machine readable instructions that may be executed to implement the example SKU categorizer of FIGS. 1 and 5 and/or to assign the SKU prediction an assurance level.

FIG. 12 is a block diagram of an example processor system that may execute the machine readable instructions represented by FIGS. 7, 8, 9, 10, and/or 11 to implement the apparatus of FIGS. 1, 4, 5 and/or 6, and/or to implement the data structures of FIGS. 2 and/or 3.

### DETAILED DESCRIPTION

Examples disclosed herein may be used to assign purchased products to one or more categories to when a transaction record (e.g., information regarding the product and the purchase of the product) is received or otherwise acquired that does not contain one or more indexable identifiers (e.g., does not include a Universal Product Code (UPC), an International Article Number (EAN), a Japanese Article Number (JAN), an International Standard Book Number (ISBN), a Manufacturer Part Number (MPN), a Stock Keeping Unit (SKU), etc.). As used herein, an indexable identifier is an alphanumeric value used to uniquely identify a product. An indexable identified may be assigned to the product by, for example, a manufacturer, a merchant, a Research Measurement Entity (RME), and/or any other appropriate entity. A transaction record may include, for example, a transaction identifier (ID), a product description (e.g., information that describes features and/or benefits of the product), product metadata (e.g., weight, dimensions, country of manufacture, indexable identifier, etc.), merchant identifier (e.g., an alphanumeric code that identifies the entity (e.g., a wholesaler, a club store, a retailer, etc.) that sold the product and/or processed the product transaction) and/or price. The RMEs offer data, analysis, and/or services to help merchants (e.g., wholesalers, club stores, retailers, etc.), manufacturers, advertisers, and/or marketers to measure and/or analyze products purchased by consumers to, for example, develop marketing plans, plan product features, and/or plan store layout, etc.

To facilitate this measurement and/or analysis (e.g., what categories sell well together, what categories are popular, etc.), purchased products are categorized. A transaction processor (e.g., a brick-and-mortar merchant, an e-commerce merchant, a credit card processor, etc.) sends a transaction record, including a product description, to the RME. As used herein, the product description is a natural language description of one or more characteristics of the product. An example natural language product description is, “New from Nabisco. Oreo Chocolate Creme Cookies. Chocolate sandwich cookies with a delicious chocolate creme center. Chocolate flavor, pack of 4 435 g packages.” As used here, a merchant is defined to be an entity that sells products and/or services (e.g., retailers, wholesalers, club stores such as Costco, warehouse stores, co-ops such as REI, e-commerce retailers, etc.).

Some transaction records include indexable identifiers associated with products (e.g., as part of the product metadata). For example, a transaction record for a product sold through a point-of-sale system may include an indexable identifier obtained by scanning a barcode on the product (e.g., printed on the product packaging material). However, some transactions records do not include an indexable identifier. For example, a product sold through an e-commerce website may not include the product's indexable identifier to the transaction record (e.g., the indexable identifier is not included in the product metadata). Further, some merchants may reuse indexable identifiers for similar products (e.g., product variants with different flavors, product variants in different colors, etc.).

Transaction records may be separated into three types. A first type of transaction records include an indexable identifier (e.g., as part of the product metadata). In some examples, transaction records with indexable identifiers may be categorized by retrieving the category from a product database using the indexable identifiers (e.g., a barcode printed on the product packaging, a UPC included in the product metadata, etc.). In some examples, when the product database does not contain the indexable identifier (e.g., new products, uncategorized products, etc.), the product may be categorized by calculating one or more confidence levels for one or more candidate categories. In some such examples, the transaction record may be flagged for review and/or to be added to the product database. In some examples, when an indexable identifier returns more than one entry from the product database, the transaction record may be categorized with the category associated with the entries. In some such examples, the transaction record is flagged to receive an SKU prediction.

A second type of transaction records do not include an indexable identifier, but may include a product description. Transaction records that do not include indexable identifiers, but include product descriptions may be categorized by calculating one or more confidence levels for one or more candidate categories. A third type of transaction record does not include an indexable identifier and does not include a product description. Such transaction records may be flagged for manual categorization or may be discarded.

In examples disclosed herein, the RME receives or otherwise retrieves transaction records from one or more transaction processors. To categorize products corresponding to transaction records of the second type (i.e., transaction records that do not contain indexable identifiers), the RME maintains a list of categories (e.g., children's clothing, baby products, shoes, personal electronics, confectionary products, etc.) and a list of descriptors (e.g., chocolate flavored, breathable, organic, lotion, etc.) associated with the categories. As used herein, descriptors are defined to be descriptive words, morphemes, phrases and/or characters which describe product characteristics. In examples disclosed here, the RME compiles a database of the categories and respective descriptors. Because products from different categories can have one or more of the same product characteristics (e.g., “cherry flavor” for “confectionary products” and “cherry flavor” for “soft drinks”), the same descriptor (e.g., “cherry flavor”) may be associated with more than one category (e.g., “confectionary products” and “soft drinks”).

In some examples, the database of categories with descriptors is developed by categorizing and assigning descriptors to products. For example, the RME and/or another entity (e.g., the product manufacturer, merchant(s), etc.) may assign categories and descriptors to the products in a manufacturer's catalogue before transaction records corresponding to those products are processed. The database of categories associates categories with metrics related to descriptors. A first example metric is the number of products in a category that have been assigned a particular descriptor. For example, 325 products in the “soft drink” category may be assigned the “cherry flavor” descriptor. A second example metric is the total number of products across all categories that have been assigned a particular descriptor. For example, 761 products, throughout all categories, may be assigned the “cherry flavor” descriptor. A third example metric is the total number of products assigned to a category. For example, 5302 products may be assigned to the “soft drink” category.

In examples disclosed herein, descriptors are associated with weighted values indicative of the predictive value of that descriptor for a given category. In some such examples, an example weighted value indicates what percentage of the total usage of the descriptor corresponds to products in a given category. That is, out of all the products associated with the descriptor, the weighted value is the percentage of the products assigned the given category. For example, 23% of the products containing the “cherry flavor” descriptor may be in the “confectionary” category and 12% of the products containing the “cherry flavor” descriptor may be in the “soft drink” category. Another example weighted value may indicate what percentage of products in a given category have a particular descriptor. For example, 5% of the products in the “confectionary” category may contain the “cherry flavor” descriptor.

In some examples disclosed herein, a descriptor is associated with a different weighted value for different categories. For example, descriptor “cherry flavor” may have a weighted value of 0.034 for the “confectionary products” category and a weighted value of 0.002 for the “soft drink” category. In such an example, the “cherry flavor” descriptor is more predictive of the “confectionary product” category as compared to the “soft drink” category. In other words, in this example, the “cherry flavor” descriptor has a greater likelihood of being associated with the “confectionary product” category as compared to the “soft drink” category. In examples described below, the weighted values are used to categorize products without indexable identifiers.

When a product description is included in a transaction record received from the transaction processor, the product description may be in a raw input form (e.g., in natural language so that a consumer can understand the product description). In examples disclosed herein, this raw input data is parsed to extract useful information to be stored in a standardized structure (e.g., a database record with fields corresponding to the useful information, an extensible markup language (XML) file with tags corresponding to the useful information, etc.). As a result, raw input data containing the natural language product description is transformed into standardized input data. Natural language product descriptions may include descriptive words and/or phrases, packaging information, function words and/or characters (e.g., counters, particles, articles, prepositions, conjunctions, etc.), lines breaks, and/or spaces.

To parse the natural language product description, information regarding packaging may be retrieved and/or removed from the natural language product description. Additionally or alternatively, function words and/or characters, spaces, line breaks and/or unknown words may also be removed from the product description. A set of product descriptors for the product may be generated by comparing the remaining product description to a list of descriptors defined by the RME. For example, the following may be a product description: “Pampers premium soft cotton XL diapers for boys, 18 count, 1 package, new, quality product, free shipping to most regions.” In this example, the generated set of product descriptors may be {pampers, premium, soft cotton, diapers, boys, new, quality product, region}.

In some examples, to categorize the product, a confidence level is calculated for one or more categories based on the weighted values for the list of descriptors. In some examples, a confidence level may be calculated for each category on the list of categories of interest maintained by the RME or any other appropriate organization. In some examples, confidence levels are calculated for categories that meet a selection criteria. An example selection criteria may be based on the type of goods sold by a merchant. For example, if a merchant only sells food related products, confidence levels for only food related categories may be calculated for that merchant. The product is assigned a category based on the calculated confidence levels. In some examples, a confidence level for a “non-audit” category may be calculated. In some such examples, transaction records categorized in the “non-audit” category are flagged for further review. Transaction records categorized in the “non-audit” category may, for example, represent new products and/or a product in a category not included in the confidence calculation (e.g., a category that does not meet the selection criteria, a new category, etc.).

In some examples, after assigning a category to a product, an SKU is predicted for the product using information (e.g., packaging information, flavor information, price, etc.) retrieved during the processes of parsing raw input data into standardized input data. The RME may maintain a database of SKUs. The SKU database may contain information to correlate an SKU with a product. For example, the SKU database may associate an SKU with a category, a set of SKU descriptors, a brand, a manufacturer, packaging information (e.g., size information, number of individual units within a package, etc.), flavor, and/or price, etc. Example SKU information may indicate that the SKU in in the “diapers” category, is associated with the “Pampers” brand, is manufactured by “P&G”, has the packaging information of {18 count, XL}, and has a set of SKU descriptors containing {diaper, soft cotton, premium, super dry, flexible}.

For the purpose of generating one or more candidate SKUs, the set of product descriptors associated with the transaction record is compared to sets of SKU descriptors for one or more SKUs in the SKU database to calculate match percentages, as described in further detail below. In addition to the match percentage, other factors, such as brand, flavor, price and/or packaging information, etc., may be used to predict an SKU for the product. For example, one or more SKUs in the “diapers” category in the SKU database may be retrieved, and a match percentage may be calculated for the retrieved SKUs by comparing the set of SKU descriptors to the set of product descriptors. The SKU(s) with the highest match percentage may be selected. The brand, the packaging information (e.g., “18 count” and “XL”), and/or the flavor information, etc. associated with the SKU(s) with the highest match percentage may be compared to information in the standardized input data (e.g., packaging information, flavor information, etc.). One of the SKU(s) may be selected as the SKU prediction based on the comparison. In some examples, the SKU with the most matching information (e.g., brand, manufacturer, flavor information, packaging information, etc.) is selected.

Additionally, in some examples, an assurance level is assigned to the SKU prediction. In some such examples, the assurance level represents a relative confidence that the SKU prediction is accurate. In some examples, the assurance level is based on one or more assurance criteria. In some examples, assurance criteria include the brand, assigned category, match percentage, packaging information, flavor information, one or more key attributes and/or price. In some examples, the assurance level is used to determine a level of scrutiny that an SKU prediction receives by, for example, quality control.

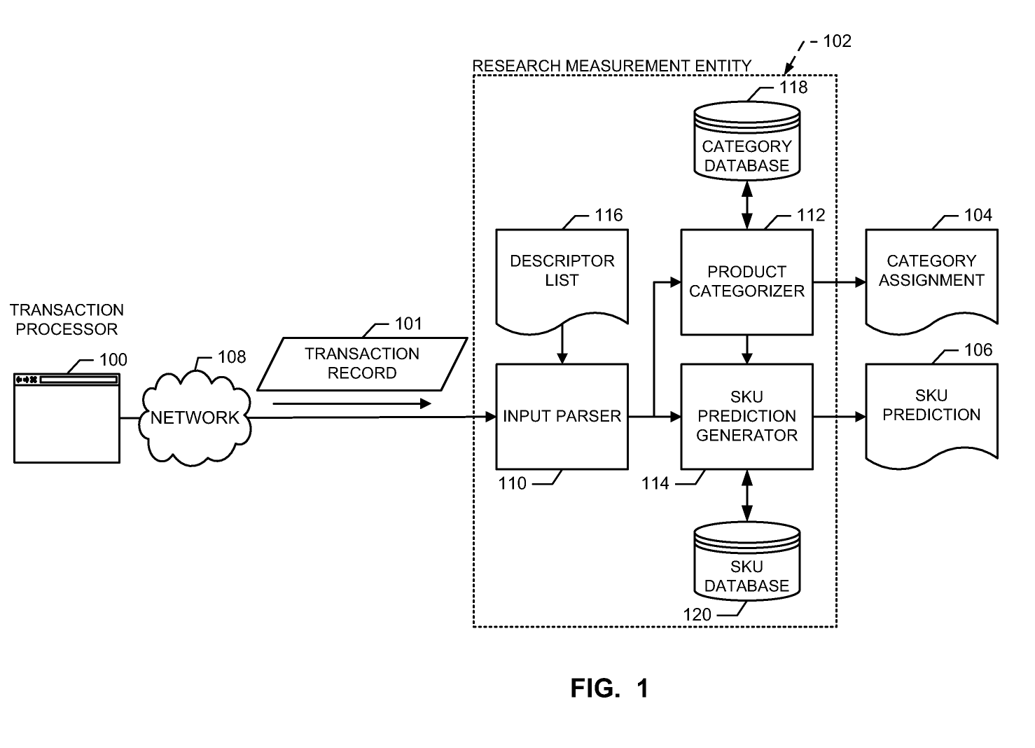

FIG. 1 illustrates an example transaction processor 100 (e.g., a merchant such as a brick-and-mortar retailer, an e-commerce retailer, a credit card processor, etc.). The transaction processor of the illustrated example provides example transaction records 101 corresponding to products purchased and/or processed through the transaction processor 100 to an example research measurement entity (RME) 102. The example transaction record 101 of FIG. 1 represents a purchased product. In some examples, a customer may generate multiple transaction records 101 for a purchase (e.g., a transaction record 101 for each item purchased). In the illustrated example, the transaction record 101 includes a product description associated with information corresponding to a transaction (e.g., type of transaction, a transaction ID, merchant ID, etc.). In some examples, the transaction record 101 also includes product metadata (e.g., weight, dimensions, country of manufacture, etc.). In the illustrated example of FIG. 1, the RME 102 processes a transaction record 101 to generate a product category assignment 104 and/or a stock keeping unit (SKU) prediction 106 corresponding to a product associated with the transaction record 101. The example transaction processor 100 of FIG. 1 communicates with the example RME 102 through an example network 108 (e.g., the Internet, a local area network, a wide area network, etc.) via wired and/or wireless connections (e.g., a cable/DSL/satellite modem, a cell tower, etc.).

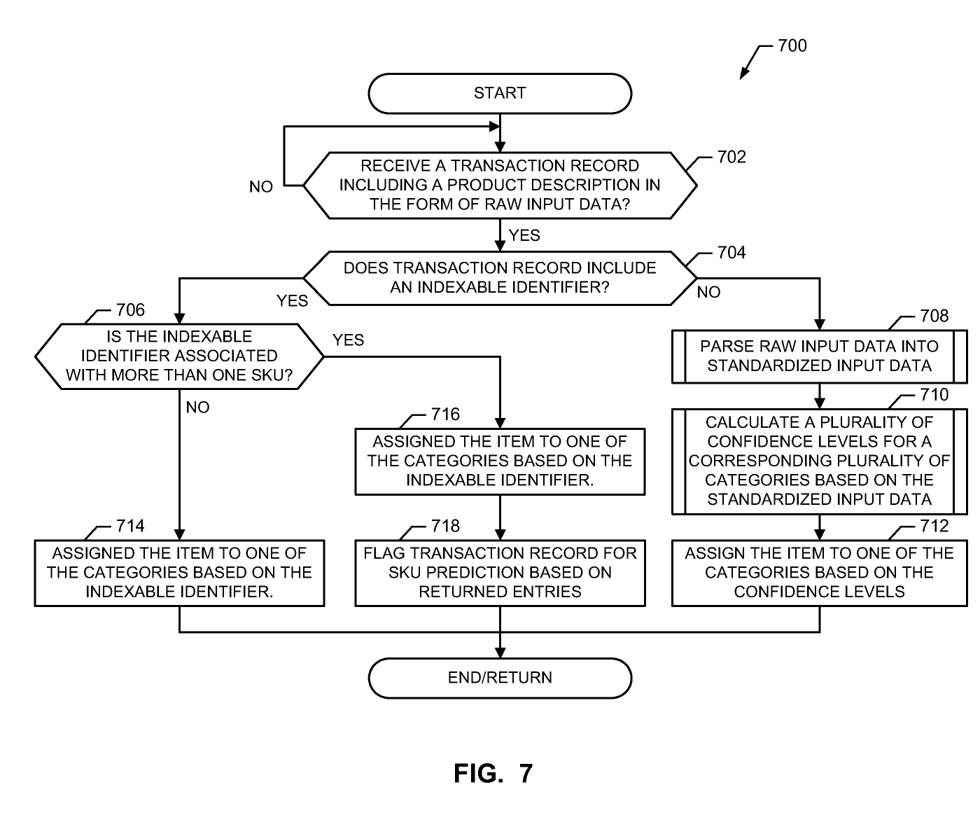

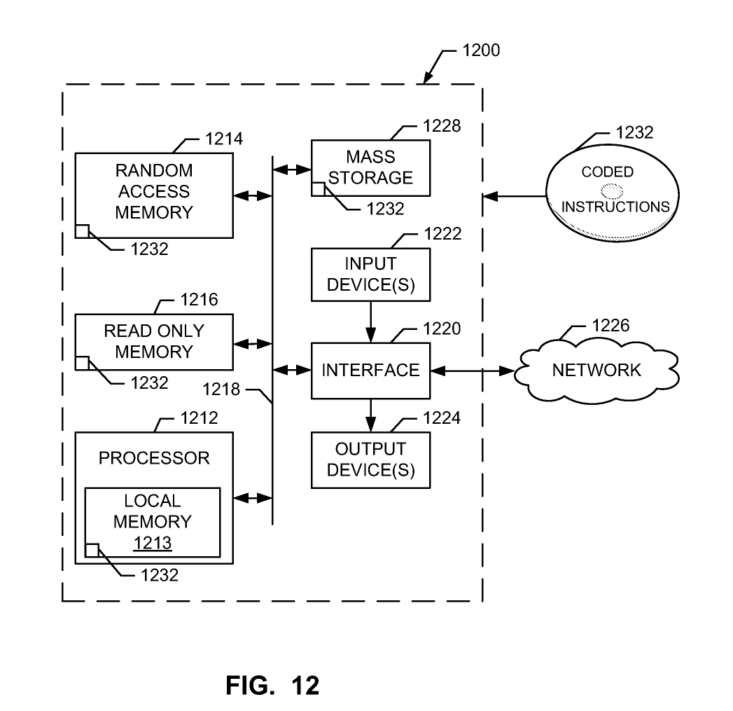

The RME 102 of the illustrated example of FIG. 1 includes an example input parser 110, an example product categorizer 112, and an example SKU prediction generator 114. The example input parser 110 is structural to transform raw input data (e.g., a product description in natural language) into standardized input data (e.g., data in a form that the product categorizer 112 and/or the SKU 114 can process). The example product categorizer 112 is structural to assign a category (e.g., from a list of candidate categories) to a purchased product represented by an example transaction record 101. The example SKU prediction generator 114 is structural to predict an SKU for the product represented by the example transaction record 101. Some examples include means for converting a natural language product description, means for associating confidence levels with candidate categories, means for assigning a product to one of candidate categories and/or means for assigning a stock keeping unit prediction. In the illustrated example of FIG. 1, the means for converting a natural language product description is the example input parser 110, the means for associating confidence levels with candidate categories is the example product categorizer 112, the means for assigning a product to one of candidate categories is the example product categorizer 112, and the means for assigning a stock keeping unit prediction is the example SKU prediction generator 114. Each of the means for converting a natural language product description, the means for associating confidence levels with candidate categories, the means for assigning a product to one of candidate categories and/or the means for assigning a stock keeping unit prediction may be implemented, for example, by a field-programmable gate array (FPGA), Application Specific Integrated Circuit (ASIC), discrete and/or integrated circuitry, a microcontroller, and/or a processor 1212 of FIG. 12 executing the instructions of FIGS. 7, 8, 9, and/or 10.

In the illustrated example of FIG. 1, the RME 102 maintains a descriptor list 116 to identify descriptors in the raw product description. The example descriptor list 116 of FIG. 1 contains a set of product descriptors used by the example RME 102 to describe product characteristics. The example input parser 110 of FIG. 1 uses the example descriptor list 116 to identify one or more descriptors used in a product description (e.g., a natural language description) supplied as part of the transaction record 101 provided by the example transaction processors 100. In the illustrate example of FIG. 1, the RME 102 maintains a category database 118 to store associations between descriptors (e.g., descriptors from descriptor list 116), categories defined by the RME 102, and/or weighted values (e.g., weighted values for a particular descriptor depending on which category with which it is associated).

The example product categorizer 112 of FIG. 1 uses the example category database 118 to calculate confidence levels used to categorize the product. In the example illustrated in FIG. 1, the RME 102 maintains an SKU database 120 to store information (e.g., brand, manufacturer, packaging, flavor, etc.) related to one or more SKUs for products (e.g., products the RME 102 has classified and assigned descriptors from the descriptor list 116). After a product has been assigned a category (e.g., one of the categories in the category database 118), the example SKU prediction generator 114 predicts an SKU for the product from the SKUs in the example SKU database 120 based on the category assigned by the example product categorizer 112. In some examples, the SKU prediction generator 114 also assigns an assurance level to the SKU prediction 106.

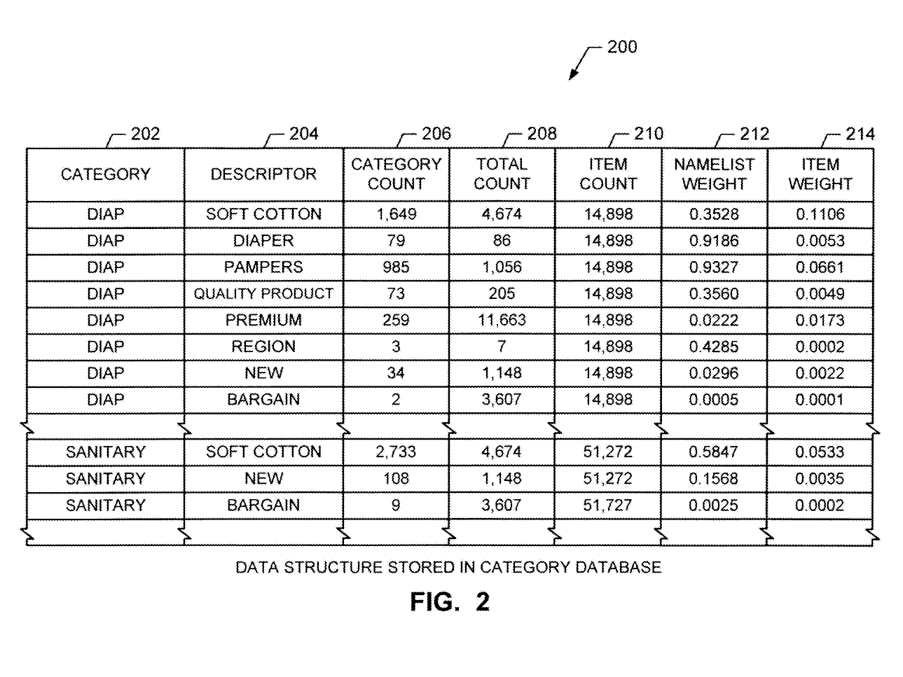

FIG. 2 depicts an example data structure 200 that may be generated and/or maintained by the example RME 102 of FIG. 1 and stored in the example category database 118 of FIG. 1. In the illustrated example of FIG. 2, the data structure 200 includes categories 202 associated with descriptors 204 (e.g., descriptors on the descriptor list 116), category counts 206, total counts 208, item counts 210, name list weighted values 212, and/or item weighted values 214. The categories 202 of the illustrated example are categories defined by the RME 102 (FIG. 1) or any other suitable organization to categorize products. The example category counts 206 of FIG. 2 reflect the number of products associated with the example category 202 that include the corresponding descriptor 204. The example total counts 208 of FIG. 2 reflect the number of products in all example categories 202 that have the corresponding descriptor 204. The example total item counts 210 of FIG. 2 reflect the total number to products assigned to the corresponding category 202. To generate the example category counts 206, the example total counts 208, and/or the example item counts 210, the RME 102 of the illustrated example assigns one or more example descriptors 204 to one or more products and assigned those products to corresponding categories 202.

In the example illustrated in FIG. 2, the name list weighted value (NLW) 212 is defined in a manner consistent with example Equation (1).

$$NLW = \frac{CC}{TC} \qquad Equation ( 1 )$$

In Equation (1), CC is the category count 206, and TC is the total count 208. In some examples, a descriptor 204 having a relatively higher name list weighted value 212 has a greater likelihood of predicting which category a product belongs to as compared with a descriptor 204 having a relatively lower name list weighted value 212.

In the illustrated example, the item weighted value (IW) 214 is defined in a manner consistent with example Equation (2).

$$IW = \frac{CC}{IC} \qquad Equation ( 2 )$$

In Equation (2), CC is the category count 206, and IC is the item count 210. In some examples, a descriptor 204 with a higher item weighted value 214 appears more frequently within a corresponding category 202. Thus, a descriptor 204 with a higher item weighted value 214 may be a greater predictor of which category 202 the product belongs to.

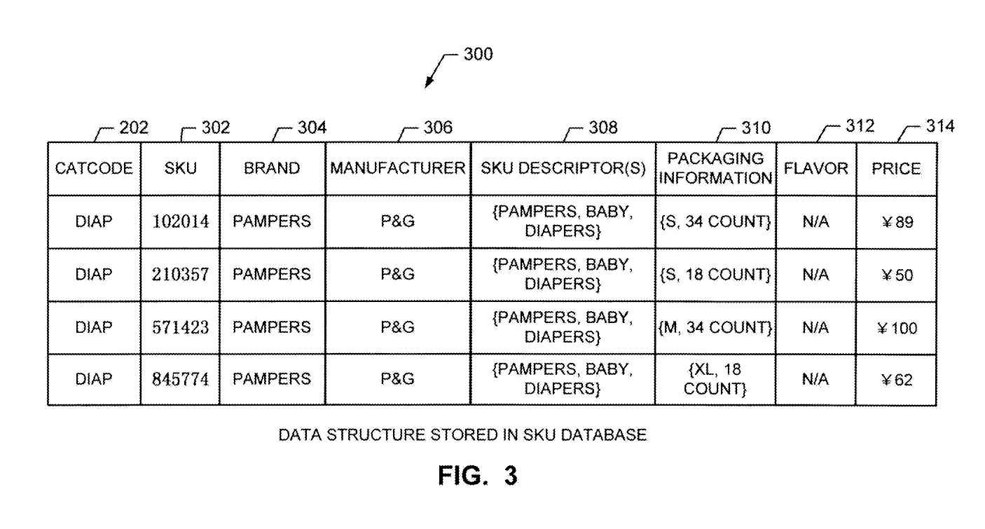

FIG. 3 depicts an example data structure 300 that may be stored in the example SKU database 120 (FIG. 1) and retrieved by the example SKU prediction generator 114 of FIG. 1 to provide information used to predict an SKU 302. In the example illustrated in FIG. 3, the data structure 300 includes SKUs 302 associated with corresponding categories 202, corresponding brands 304, corresponding manufacturers 306, corresponding sets of SKU descriptors 308, corresponding packaging information 310, corresponding flavor information 312, and corresponding price information 314. In some examples, the price data 314 is expresses as a statistically calculated value (e.g., mean price, average price, mode price, etc.), or is expressed as a range of values (e.g., ¥50-¥89, etc.). While the illustrated example data structure 300 of FIG. 3 includes SKU information associated with brands, manufacturers, and flavor, in some examples, the data structure 300 may associate additional and/or alternative information with the SKUs 302.

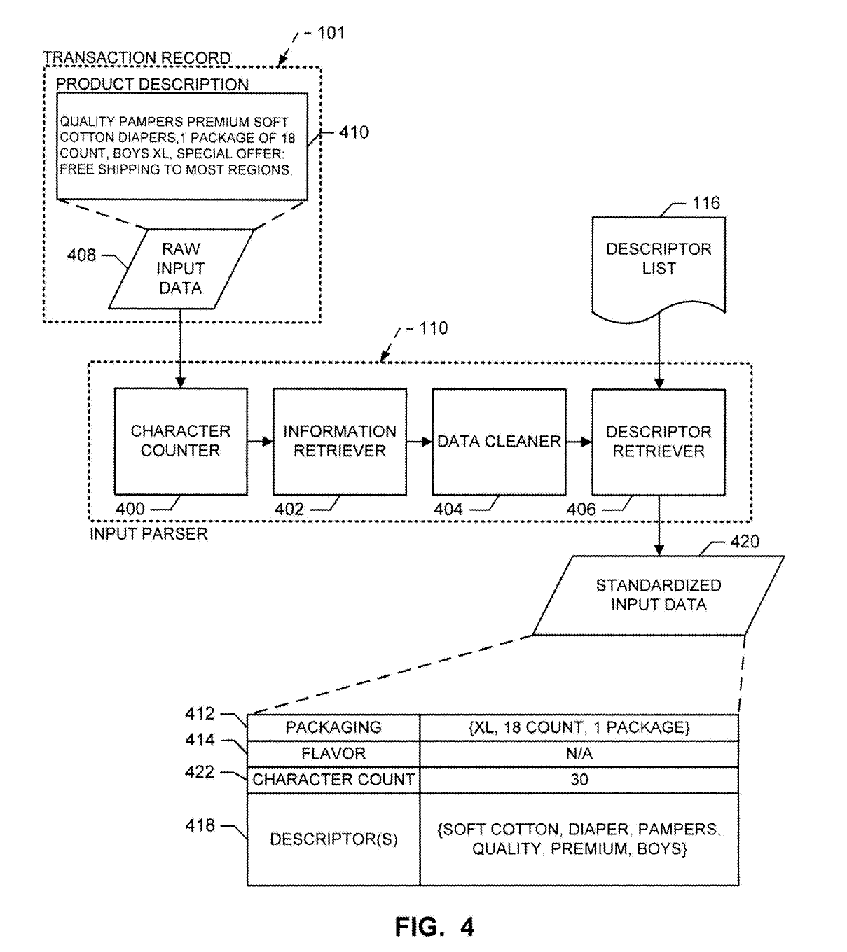

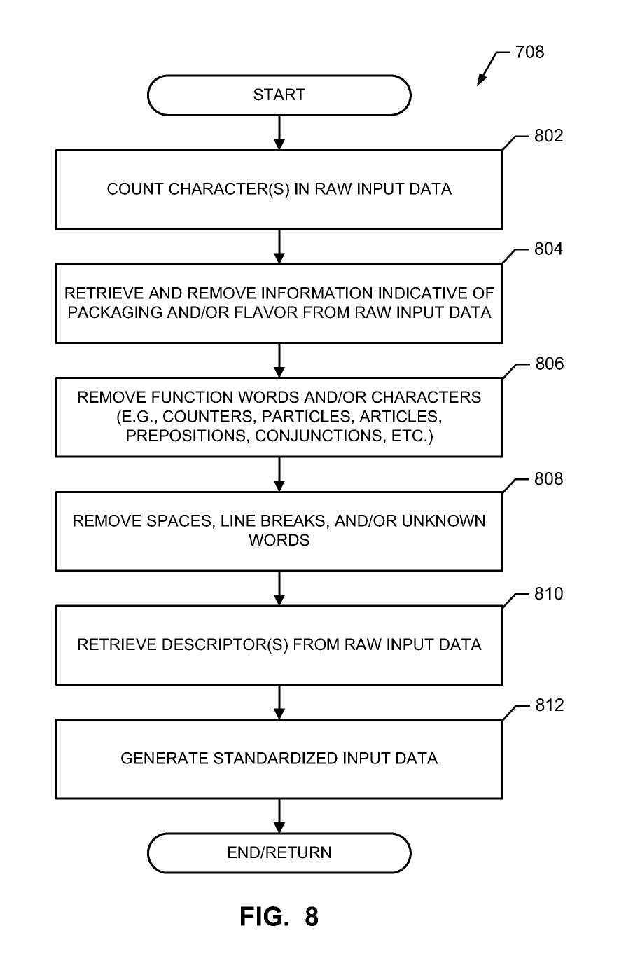

FIG. 4 illustrates an example implementation of the input parser 110 of FIG. 1 to standardize product descriptions. For example, different transaction processors (e.g., the transaction processor 101 of FIG. 1) may include product descriptions with different formats and/or in formats not suitable to be processed (e.g., natural language product descriptions). In the illustrated example of FIG. 4, the input parser 110 includes a character counter 400, an information retriever 402, a data cleaner 404, and a descriptor retriever 406. Some examples include means for counting characters, means for identifying packaging information, means for cleaning the raw input data, and/or means for identifying product descriptors. In the example illustrated in FIG. 4, the means for counting characters is the example character counter 400, the means for identifying packaging information is the example information retriever 402, means for cleaning the raw input data is the example data cleaner 404, and the means for identifying product descriptors is the example descriptor retriever 406. Each of the means for counting characters, the means for identifying packaging information, the means for cleaning the raw input data, and/or the means for identifying product descriptors may be implemented, for example, by an FPGA, an ASIC, discrete and/or integrated circuitry, a microcontroller, and/or the processor 1212 of FIG. 12 executing the instructions of FIG. 8.

The example character counter 400 of FIG. 4 receives an example transaction record 101 containing a product description 410 in the form of example raw input data 408 from the one or more transaction processors 100 (FIG. 1). The example character counter 400 of FIG. 4 is provided to count the number of characters (e.g., Chinese logographic characters (Hanzi), etc.) and/or words (e.g., for languages that use the Latin alphabet, etc.) in the example product description 410. In some examples, characters and/or words are counted based on a smallest meaningful morphological unit of a language (e.g., words in English, logographic characters in Chinese, etc.). The example information retriever 402 of FIG. 4 is provided to retrieve useful information other than descriptors from the raw input data 408. In the example illustrated in FIG. 4, the information retriever 402 retrieves and removes packaging information 412, and/or flavor information 414 from the product description 410. The example data cleaner 404 of this example removes function words and/or characters (e.g., counters, particles, articles, prepositions, conjunctions, etc.), spaces, line breaks and/or unknown words from the example product description 410.

In the example illustrated in FIG. 4, the descriptor retriever 406 processes the portion of the product description 410 remaining after operations by the data cleaner 404. In some examples, the descriptor retriever 406 simplifies the remaining portion of the product description 410 (e.g., converts traditional Chinese characters to simplified Chinese characters, convert standard English to Basic English, etc.). The example descriptor retriever 406 of this example matches the remaining portion of the product description 410 to the descriptors (e.g., descriptors 204 of FIG. 2) on the descriptor list 116 of FIG. 1 to form a set of product descriptors 418. In some examples, the remaining portion of the product description 410 (if any) is discarded.

In the example illustrated in FIG. 4, the input parser 110 outputs standardized input data 420. The example standardized input data 420 illustrated in FIG. 4 includes the example packaging information 412 and the example flavor information 414 retrieved by the information retriever 402, the example set of product descriptors 418 retrieved by the description retriever 406, and an example character count 422 calculated by the character counter 400. In some examples, the character count 422 is the number of characters and/or words in the product description 410. The example standardized input data 420 is used to calculate confidence levels for selecting a category 202, and/or used to predict an SKU (e.g., an SKU 302 of FIG. 3).

While an example manner of implementing the input parser 110 of FIG. 1 is illustrated in FIG. 4, one or more of the elements, processes and/or devices illustrated in FIG. 4 may be combined, divided, re-arranged, omitted, eliminated and/or implemented in any other way. Further, the example character counter 400, the example information retriever 402, the example data cleaner 404, the example descriptor retriever 406 and/or, more generally, the example input parser 110 of FIG. 1 may be implemented by hardware, software, firmware and/or any combination of hardware, software and/or firmware. Thus, for example, any of the example character counter 400, the example information retriever 402, the example data cleaner 404, the example descriptor retriever 406 and/or, more generally, the example input parser 110 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example character counter 400, the example information retriever 402, the example data cleaner 404 and/or the example descriptor retriever 406 is/are hereby expressly defined to include a tangible computer readable storage device or storage disk such as a memory, a digital versatile disk (DVD), a compact disk (CD), a Blu-ray disk, etc. storing the software and/or firmware. Further still, the example input parser 110 of FIG. 1 may include one or more elements, processes and/or devices in addition to, or instead of, those illustrated in FIG. 4, and/or may include more than one of any or all of the illustrated elements, processes and devices.

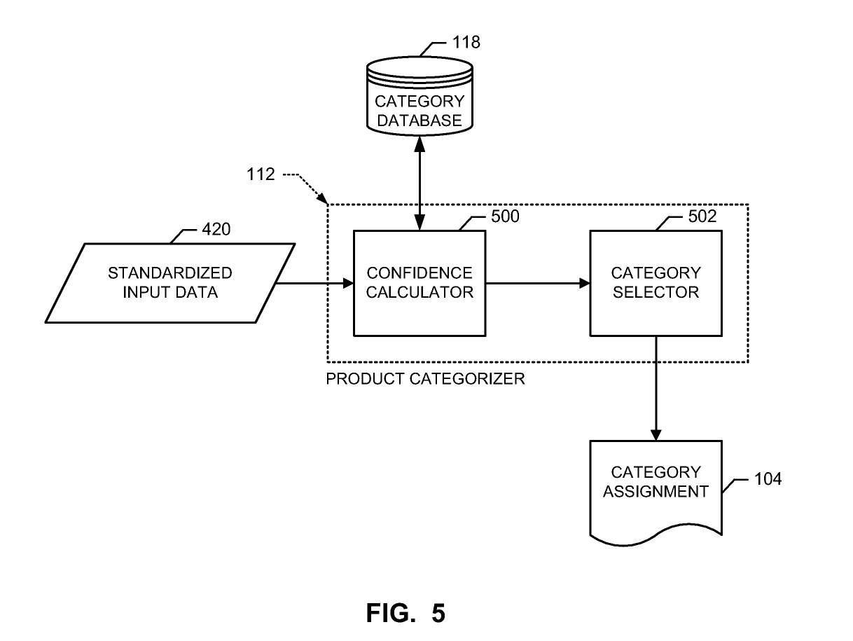

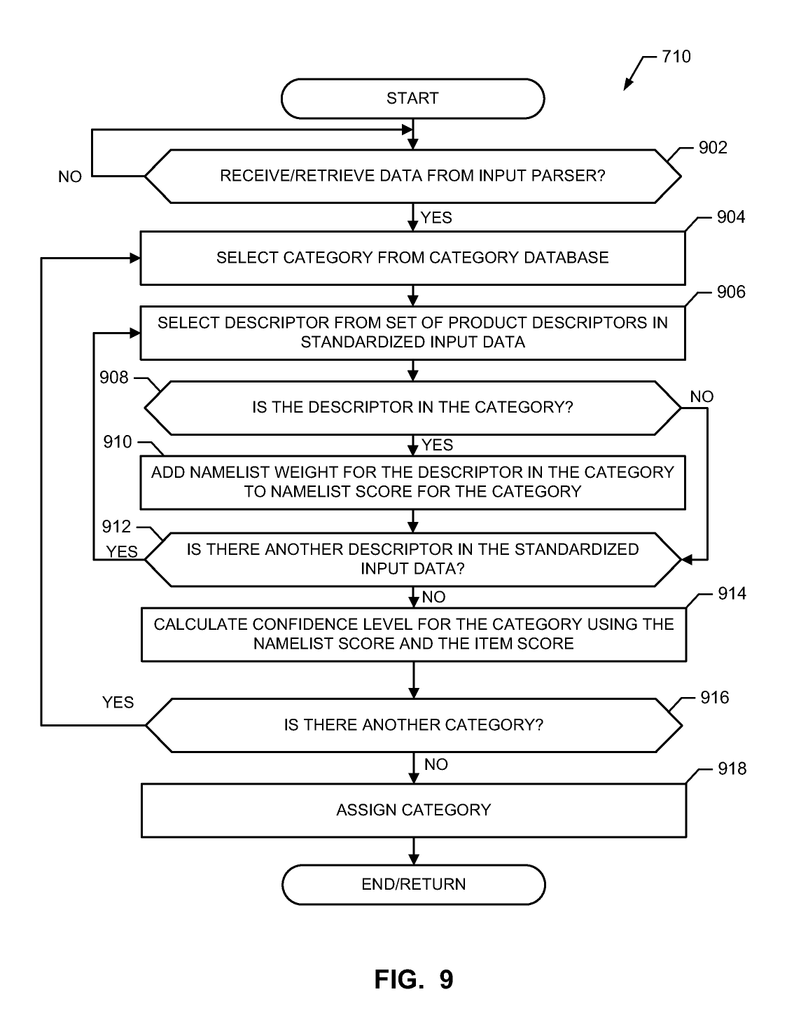

FIG. 5 illustrates an example implementation of the product categorizer 112 of FIG. 1. In the illustrated example of FIG. 5, the product categorizer 112 includes a confidence calculator 500 and a category selector 502. Some examples include means for calculating a confidence level, means for calculating weighted values, and/or means for selecting a category. In the illustrated example of FIG. 5, the means for calculating a confidence level is the example confidence calculator 500, means for calculating weighted values is the example confidence calculator 500, and means for selecting a category is the category selector 502. Each of the means for calculating a confidence level, the means for calculating weighted values, and the means for selecting a category may be implemented, for example, by an FPGA, an ASIC, discrete and/or integrated circuitry, a microcontroller, and/or the processor 1212 of FIG. 12 executing the instructions of FIG. 9.

The example product confidence calculator 500 of FIG. 5 is provided to calculate a confidence level for one or more categories (e.g. categories in the category database 118 of FIG. 1). The example confidence calculator 500 receives and/or otherwise retrieves the standardized input data 420 (FIG. 4) from the input parser 110 (FIGS. 1 and 4). In the illustrated example of FIG. 5, the confidence calculator 500 calculates a confidence level (value) for one or more RME 102 defined categories. In some examples, the confidence calculator 500 calculates a confidence level for all of the RME 102 defined categories (e.g., the categories 202 of FIG. 2). In some examples, the confidence calculator 500 calculates confidence levels for categories based on a selection criteria (e.g., categories related to clothes, categories related to food, categories related to children, etc.). To calculate a confidence level for a particular category of interest, the example confidence calculator 500 calculates a name list weight score (NWS) and an item weight score (IWS) for that category of interest.

In the illustrated example, the NWS is defined in a manner consistent with example Equation (3).

$$NWS = {\sum }_{i = 1}^{n} \frac{{NLW}_{i} \times {LD}_{i}}{CHAR} \qquad Equation ( 3 )$$

In the illustrated example, the confidence calculator 500 retrieves a name list weighted value (NLW) (e.g., the name list weighted value 212 of FIG. 2 calculated by the example RME 102 consistent with example Equation (1) for each descriptor (i), 1 through n, (e.g., the descriptors 204 of FIG. 2) in a set of product descriptors (e.g., the set of product descriptors 418 of FIG. 4) from the category database 118 for one of the categories (e.g., category 202 of FIG. 2) for which a confidence level is being calculated. Each retrieved name list weighted value is multiplied by the length of the descriptor (LD) (e.g., a value representing the number of characters in the descriptor) and divided by a character count value (CHAR) (e.g., the character count 422 of FIG. 4). The resulting values are added together to calculate the name list weight score for the selected category of interest.

In the illustrated example, the IWS is defined in a manner consistent with example Equation (4).

$$IWS = {\sum }_{i = 1}^{n} \frac{{IW}_{i} \times {LD}_{i}}{CHAR} \qquad Equation ( 4 )$$

In the illustrated example, the confidence calculator 500 retrieves an item weighted value (IW) (e.g., the item weighted value 212 of FIG. 2 calculated by the example RME 102 in a manner consistent with Equation (2)) for each descriptor (i), 1 through n, (e.g., the descriptor 204 of FIG. 2) in a set of product descriptors (e.g., the set of product descriptors 418 of FIG. 4) from the category database 118 for one of the categories (e.g., category 202 of FIG. 2) for which a confidence level is being calculated. Each retrieved item weighted value is multiplied by the length of the descriptor (LD) and divided by a character count value (CHAR) (e.g., the character count 422 of FIG. 4) of the characters is a description of a product (e.g., product description 410 of FIG. 4). The resulting values are added together to calculate the item weight score for the selected category of interest.

In the illustrated example, the confidence level for a category (c_{CAT}) is defined in a manner consistent with example Equation (5).

c_{CAT}=NWS_{CAT}×IWS_{CAT} Equation (5)

The name list weight score for the category (NWS_{CAT}) is multiplied by the item weight score for the category (IWS_{CAT}). In the illustrated example, the confidence calculator 500 uses example Equations (3)-(5) to calculate a confidence level for each category of interest. In other words, the confidence calculator 500 may perform any number of iterations of Equations (3)-(5) to evaluate the standardized input data 420 to identify the most appropriate category.

The category selector 502 of this example is provided to choose one of the categories 202 based on the confidence levels calculated by the confidence calculator 500. In the illustrated example of FIG. 5, the category selector 502 receives and/or otherwise retrieves the confidence levels calculated by the confidence calculator 500 associated with one or more of the respective categories of interest. The example category selector 502 of FIG. 5 selects one of the categories received and/or otherwise retrieved from the confidence calculator 500 and generates a category assignment 104 (FIG. 1) based on the calculated confidence levels. In some examples, the category selector 502 assigns the product the category having the highest relative confidence level when compared to any number of other categories of interest (e.g., the categories 202 of FIG. 2).

While an example manner of implementing the product categorizer 112 of FIG. 1 is illustrated in FIG. 5, one or more of the elements, processes and/or devices illustrated in FIG. 5 may be combined, divided, re-arranged, omitted, eliminated and/or implemented in any other way. Further, the example confidence calculator 500, the example category selector 502 and/or, more generally, the example product categorizer 112 of FIG. 1 may be implemented by hardware, software, firmware and/or any combination of hardware, software and/or firmware. Thus, for example, any of the example confidence calculator 500, the example category selector 502 and/or, more generally, the product categorizer 112 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example confidence calculator 500 and/or the example category selector 502 is/are hereby expressly defined to include a tangible computer readable storage device or storage disk such as a memory, a digital versatile disk (DVD), a compact disk (CD), a Blu-ray disk, etc. storing the software and/or firmware. Further still, the example product categorizer 112 of FIG. 1 may include one or more elements, processes and/or devices in addition to, or instead of, those illustrated in FIG. 5, and/or may include more than one of any or all of the illustrated elements, processes and devices.

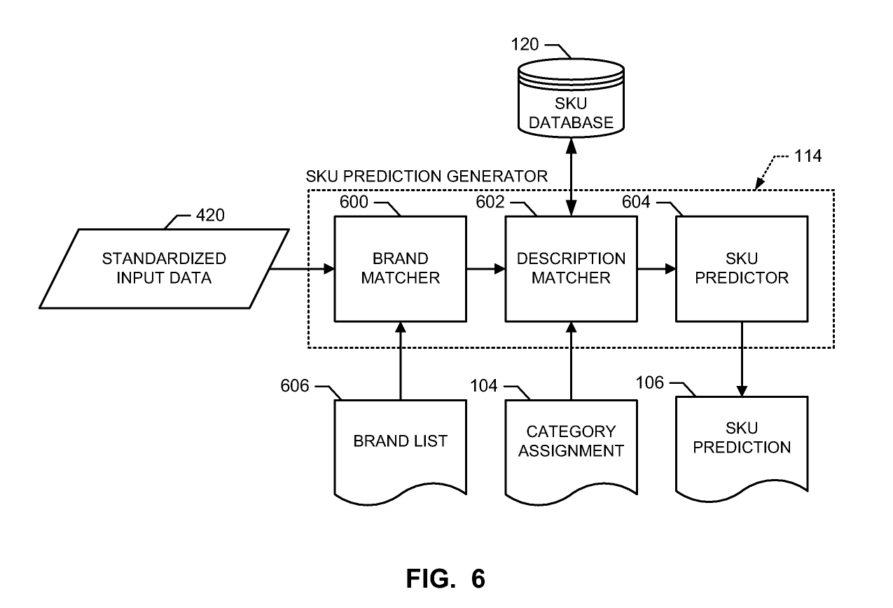

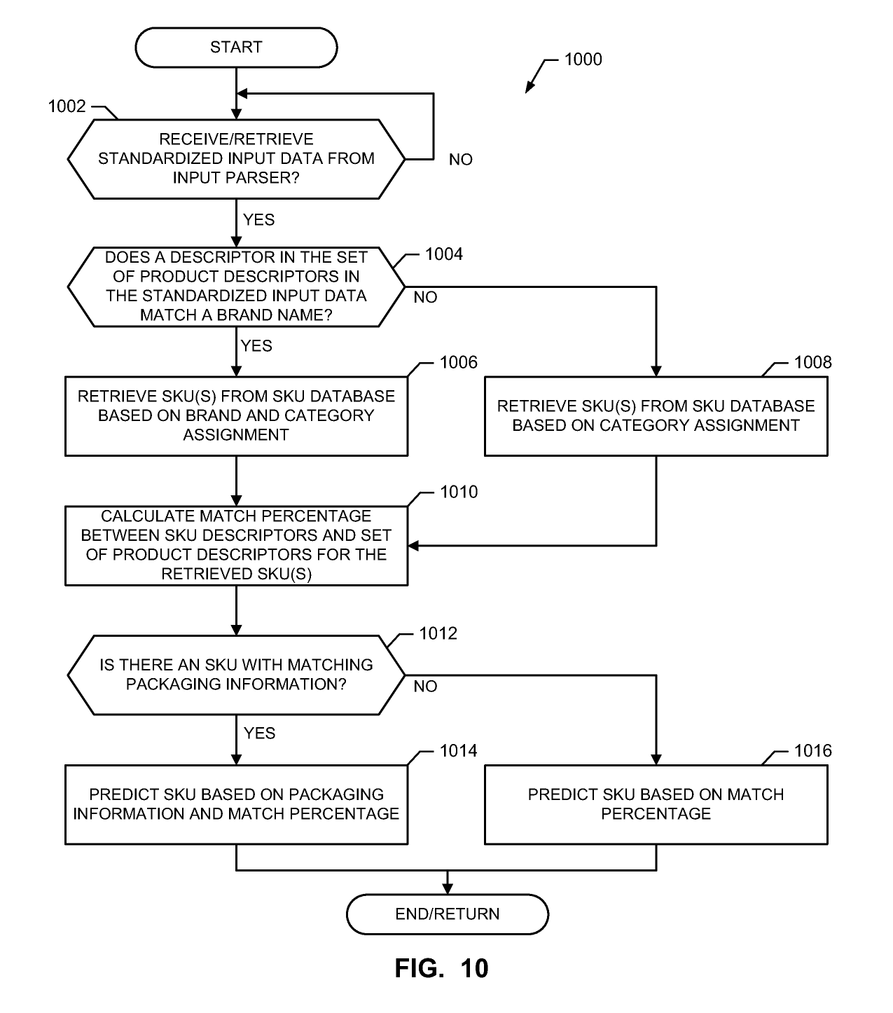

FIG. 6 illustrates an example implementation of the SKU prediction generator 114 of FIG. 1. The example SKU prediction generator 114 predicts an SKU for a product represented by a transaction record 101 (FIG. 1) for the purpose of identifying a purchased product with more specificity compared to assigning a category 202 as discussed above in connection with FIG. 5. In the illustrated example of FIG. 6, the SKU prediction generator 114 includes a brand matcher 600, a description matcher 602, and an SKU predictor 604. Some examples include means for matching a brand, means for calculating a match percentage, means for selecting a stock keeping unit, and means for assigning an assurance level. In the illustrated example of FIG. 6, the means for matching a brand is the example brand matcher 600, the means for calculating a match percentage is the example description matcher 602, the means for selecting a stock keeping unit is the example description matcher 602, and the means for assigning an assurance level is the example SKU predictor 604. Each of the means for matching a brand, the means for calculating a match percentage, the means for selecting a stock keeping unit, and/or the means for assigning an assurance level may be implemented, for example, by an FPGA, an ASIC, discrete and/or integrated circuitry, a microcontroller, and/or the processor 1212 of FIG. 12 executing the instructions of FIGS. 10 and/or 11.

The example brand matcher 600 of FIG. 6 is provided to narrow down potential SKUs. That is, if a product description (e.g., the product description 410 of FIG. 4) contains a brand name (e.g., Pampers®, Oreo®, etc.), the possible SKUs are narrowed to those for that brand. In the illustrated example of FIG. 6, the brand matcher 600 receives and/or otherwise retrieves a brand list 606 from the RME 102 (FIG. 1), which may be generated, maintained, and/or obtained by the RME 102. The example brand matcher 600 of FIG. 6 also receives and/or otherwise retrieves the standardized input data 420 from the example input parser 110 (FIGS. 1 and 4). The example brand matcher 600 determines whether the set of product descriptors 418 (FIG. 4) within the retrieved example standardized input data 420 contains a descriptor (e.g., descriptor 204 of FIG. 2) that matches a brand on the brand list 606. For example, both the brand list 606 and the set of product descriptors 418 may contain the “Pampers” descriptor. The example SKU prediction generator 114 of this example predicts an SKU whether or not the example brand matcher 600 matches a brand on the example brand list 606 with an example descriptor 204 in the set of product descriptors 418. However, as described in further detail below, matching a brand may affect the assurance level of the SKU prediction 106 and/or the number of candidate SKUs 302.

In the example illustrated in FIG. 6, the description matcher 602 retrieves information related to SKUs (e.g., the SKUs 302 of FIG. 3) from the SKU database 120 (FIG. 1) that have a category (e.g., the category 202 of FIG. 3) that matches the category assignment 104 (FIG. 1) received/retrieved from the product categorizer 112 (FIGS. 1 and 5). To narrow the candidate SKU(s) 302, in some examples, the description matcher 602 eliminates SKU(s) 302 that do not include the brand 304 identified by the brand matcher 600. In some examples, when the transaction record 101 (FIG. 1) with an indexable identifier is flagged to receive an SKU prediction 106 (e.g., the indexable identifier is associated with more than one SKU 302), the description matcher 602 narrows the candidate SKU(s) 302 to the SKUs 302 associated with the indexable identifier in the product database.

In the illustrated example of FIG. 6, for the retrieved SKUs 302, the description matcher 602 retrieves the set of SKU descriptors 308 (FIG. 3), the packaging information 310 (FIG. 3), and/or the flavor information 312 (FIG. 3). The example description matcher 602 calculates a percentage of descriptors in the set of SKU descriptors 308 that match (e.g., a match percentage) the descriptors in the set of product descriptors 418 in the standardized input data 420. In the example illustrated in FIG. 6, the description matcher 602 selects one or more candidate SKUs 302 with the highest relative match percentage. In the example illustrated in FIG. 6, to reduce the number of candidate SKUs 302 and/or to produce a stronger prediction, the description matcher 602 determines whether one of more of the candidate SKUs 302 has packaging information 310 that matches the packaging information 412 in the standardized input data 420 of the product of interest. In this example, if one or more candidate SKUs have matching packaging information 310, the candidate SKUs that do not match are eliminated (e.g., not considered candidate SKUs 302). To further narrow candidate SKUs 302, in some examples, the description matcher 602 compares the flavor information 312 of the remaining candidate SKUs with the flavor information 414 of the standardized input data 420 of the product of interest. In some such examples, the description matcher 602 selects an SKU 302 with matching packaging information 310 and matching flavor information 312. In some examples, if the candidate SKUs 302 cannot be narrowed down to one candidate SKU 302, a candidate SKU 302 is not selected.

In the example illustrated in FIG. 6, the SKU predictor 604 receives and/or otherwise retrieves the SKU 302 selected by the description matcher 602 and designates the SKU 302 as the SKU prediction 106 (FIG. 1) to be associated with the product. In some examples, the SKU predictor 604 assigns an assurance level to the SKU prediction 106 from a gradation of assurance levels (e.g., first, second, third, high, medium, low, etc.) that communicate a relative level of confidence that the SKU prediction 106 is accurate. In some examples, the assurance level is based on assurance criteria, such as, match percentage, packaging information, flavor information, more or more key attributes, and/or price. In some such examples, a first assurance level is assigned to SKU predictions 106 if (1) the match percentage associated with the SKU selected for the SKU prediction 106 is greater than a threshold match percentage (e.g., 80%) defined by the RME 120, (2) the packaging information 308 of the selected SKU matches the packaging information 412 of the standardized input data 420, and (3) the flavor information 312 of the selected SKU matches the flavor information 414 of the standardized input data 420. Additionally, in some such examples, a second assurance level is assigned to the SKU prediction 106 if (1) the match percentage is less than the threshold match percentage defined by the RME 120, but (2) the packaging information 308 of the selected SKU matches the packaging information 412 of the standardized input data 420, and (3) the flavor information 312 of the selected SKU matches the flavor information 414 of the standardized input data 420. In some such examples, all other SKU predictions 106 are assigned a third assurance level.

In some examples, the standardized input data 420 is compared to a key attribute to raise or lower the assurance level of the SKU prediction 106. In some examples, a key attribute is packaging information, a descriptor, and/or flavor information designated to be highly predictive of an SKU by the RME 102. In some such examples, the key attribute(s) are based on the category assignment 104. For example, the key attribute for products in a “diaper” category may be the size of the diaper (e.g., S, M, L, XL, etc.), the key attribute for products in a “formula” category (e.g., a “baby formula” category, an “infant milk formula” category, etc.) may be a descriptor related to formula stage (e.g., stage 1, stage 2, stage 3, etc.), and the key attribute for products in a “alcohol” category may be a descriptor related to alcohol by volume (e.g., 80 proof, 10% alcohol, etc.). In some such examples, the assurance level of the SKU prediction 106 is raised when the standardized input data 420 contains the key attribute. In some such examples, the assurance level of the SKU prediction 106 is lowered when the standardized input data 420 does not contain the key attribute.

In some examples, the standardized input data 420 is compared to price information (e.g., price information 314 of FIG. 3) to raise or lower the assurance level of the SKU prediction 106. In some examples, the SKU predictor 604 may generate a range of prices to compare to the standardized input data 420. For example, the SKU predictor 604 may generate a range of ±50% of the price information 314. For example, if the price information 314 is ¥50, the SKU predictor 604 may generate a range from ¥25 to ¥ 75. In some examples, when price information included in the standardized input data 420 satisfies the price information 314 (e.g., matches the price information 314, falls within a range given by the price information 314, falls within a range generated by the SKU predictor 604, etc.), the assurance level of the SKU prediction 106 is raised. In some examples, the assurance level of the SKU prediction 106 is lowered when the standardized input data 420 does not satisfy the price information 314 (e.g., the standardized input data 420 does not include price information, the price information falls outside a range generated by the SKU predictor 604, etc.). In some examples, the assurance level is used to determine a level of review (e.g., by quality assurance) for the SKU prediction 106. For example, SKU predictions 106 with a third assurance level may be reviewed more often than SKU predictions 106 with first or second assurance levels.

While an example manner of implementing the SKU prediction generator 114 of FIG. 1 is illustrated in FIG. 6, one or more of the elements, processes and/or devices illustrated in FIG. 6 may be combined, divided, re-arranged, omitted, eliminated and/or implemented in any other way. Further, the example brand matcher 600, the example description matcher 602, the example SKU predictor 604 and/or, more generally, the example SKU prediction generator 114 of FIG. 1 may be implemented by hardware, software, firmware and/or any combination of hardware, software and/or firmware. Thus, for example, any of the example brand matcher 600, the example description matcher 602, the example SKU predictor 604 and/or, more generally, the example SKU prediction generator 114 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example brand matcher 600, the example description matcher 602 and/or the example SKU predictor 604 is/are hereby expressly defined to include a tangible computer readable storage device or storage disk such as a memory, a digital versatile disk (DVD), a compact disk (CD), a Blu-ray disk, etc. storing the software and/or firmware. Further still, the example SKU prediction generator 114 of FIG. 1 may include one or more elements, processes and/or devices in addition to, or instead of, those illustrated in FIG. 4, and/or may include more than one of any or all of the illustrated elements, processes and devices.

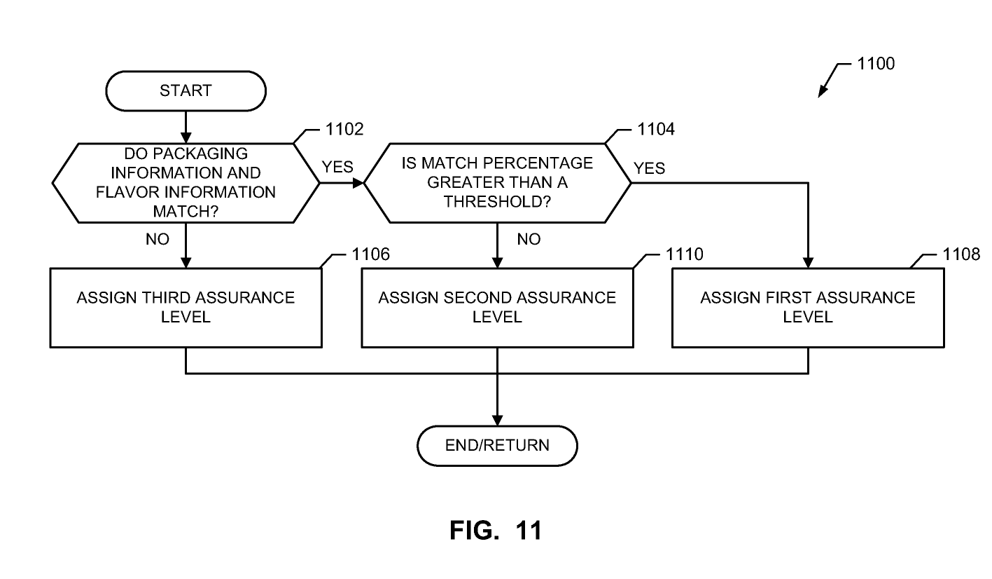

A flowchart representative of example machine readable instructions for implementing the input parser 110 and product categorizer 112 of FIG. 1 is shown in FIG. 7. A flowchart representative of example machine readable instructions for implementing the input parser 110 of FIG. 1 is shown in FIG. 8. A flowchart representative of example machine readable instructions for implementing the product categorizer 112 of FIG. 1 is shown in FIG. 9. Flowcharts representative of example machine readable instructions for implementing the SKU prediction generator 114 of FIG. 1 are shown in FIGS. 10 and 11. In this example, the machine readable instructions comprise programs for execution by a processor such as the processor 1212 shown in the example processor platform 1200 discussed below in connection with FIG. 12. The programs may be embodied in software stored on a tangible computer readable storage medium such as a CD-ROM, a floppy disk, a hard drive, a digital versatile disk (DVD), a Blu-ray disk, or a memory associated with the processor 1212, but the entire program and/or parts thereof could alternatively be executed by a device other than the processor 1212 and/or embodied in firmware or dedicated hardware. Further, although example programs are described with reference to the flowcharts illustrated in FIGS. 7, 8, 9, 10, and 11, many other methods of implementing the example input parser 110, the example product categorizer 112, and/or the example SKU prediction generator 114 may alternatively be used. For example, the order of execution of the blocks may be changed, and/or some of the blocks described may be changed, eliminated, or combined.

As mentioned above, the example processes of FIGS. 7, 8, 9, 10, and 11 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals, to exclude transitory signals, and to exclude transmission media. As used herein, “tangible computer readable storage medium” and “tangible machine readable storage medium” are used interchangeably. Additionally or alternatively, the example processes of FIGS. 7, 8, 9, 10, and 11 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals, to exclude transitory signals, and to exclude transmission media. As used herein, when the phrase “at least” is used as the transition term in a preamble of a claim, it is open-ended in the same manner as the term “comprising” is open ended.

FIG. 7 is representative of example machine readable instructions 700 which may be executed to implement the input parser 110 and the product categorizer 112 of FIG. 1 to generate a category assignment 104 (FIG. 1) for a transaction record 101 (FIG. 1) received from a transaction processor 100 (FIG. 1). Initially, at block 702, input parser 110 determines whether a transaction record 101 (FIG. 1) that includes a product description (e.g., the product description 410 of FIG. 4) in the form of raw input data 408 (FIG. 4) is received. At block 704, the input parser 110 determines whether the raw input data 408 includes an indexable identifier. If the raw input data 408 includes an indexable identifier, program control advances to block 706. Otherwise, program control advances to block 708. At block 706, the product categorizer 112 determines whether the indexable identifier is associated with more than one SKU. If the indexable identifier is associated with only one SKU, program control advances to block 714. If the indexable identifier is associated with more than one SKU, program control advances to block 716.

At block 708, the input parser 110 transforms the raw input data 408 into standardized input data 420 (FIG. 4). An example process that may be used to transform the raw input data 408 is described below in connection with FIG. 8. At block 710, the product categorizer 112 calculates a plurality of confidence levels for a respective plurality of categories (e.g., the categories 202 of FIGS. 2 and 3) based on the standardized input data 420 received/retrieved from the input parser 110. An example process that may be used to calculate confidence levels is described below in connection with FIG. 9. At block 712, the product categorizer 112 assigns the transaction record to one of the categories 202 based on the confidence levels calculated at block 710. The example program 700 of FIG. 7 then ends.

At block 714, the product categorizer 112 assigns the transaction record 101 to one of the categories 202 based on the indexable identifier. The example program 700 then ends. At block 716, the product categorizer assigns the transaction record 101 to one of the categories 202 based on the indexable identifier. At block 718, the product categorizer flags the transaction record 101 to receive an SKU prediction 106 (FIG. 1) (e.g., by the SKU prediction generator 114 of FIG. 1) based on the associated SKUs. The example program 700 then ends.

FIG. 8 is representative of example machine readable instructions 708 which may be executed to implement the example input parser 110 of FIGS. 1 and 4 to transform raw input data 408 (FIG. 4) into standardized input data 420 (FIG. 4). Generally speaking, the raw input data 408 may include product description data, but may also lack one or more indexable identifiers that, if included, would allow a convenient manner of product category identification. To facilitate categorization of a product of interest, example methods, and apparatus disclosed here transform raw input data (e.g., raw input data 408) into a standardized form to further facilitate one or more calculations that reveal a likely category of be associated with the product of interest.

Initially, at block 802, the example character counter 400 (FIG. 4) counts the characters (e.g., in Chinese, etc.) and/or words (e.g., in English, etc.) in the raw input data 408. In some examples, the characters in the raw input data 408 may input characters from one or more character sets (e.g., Chinese logographic characters, Latin alphabet letter, etc.). At block 804, the information retriever 402 retrieves and removes packaging information (e.g., packaging information 412 of FIG. 4), flavor information (e.g., flavor information 416 of FIG. 4), and/or any other information defined by the RME 102 of FIG. 1 (e.g., pricing information, etc.).

At block 806, the example data cleaner 404 removes function words and/or characters (e.g., counters, particles, articles, prepositions, conjunctions, etc.) from the raw input data 408. At block 808, the example data cleaner 404 removes spaces, line breaks and/or unknown words and characters from the raw input data 408. In other words, while the raw input data 408 may include helpful clues regarding a likely category for the product of interest, some of the raw input data 408 may be of limited use and/or otherwise irrelevant to the category designation. At block 810, the example descriptor retriever 406 compares the remaining raw input data 408 with the descriptor list 116 (FIG. 1). In some examples, the descriptor retriever 406 simplifies (e.g., converts traditional Chinese characters to simplified Chinese characters, converts standard English to Basic English, etc.) the remaining raw input data 408 before being compared to the descriptor list 116. The example descriptor retriever 406 retrieves descriptors (e.g., descriptors 204 of FIG. 2) from the raw input data 408 that match descriptors on the descriptor list 116 and forms a set of product descriptors 418 (FIG. 4). At block 812, the example descriptor retriever 406 generates the standardized input data 420 by compiling the character count 422 generated at block 802, the packaging information 412 and the flavor information 416 retrieved at block 804, and/or the set of product descriptors 418 generated at block 810. In some examples, the descriptor retriever 406 generates the standardized input data using an extensible markup language (XML) format with tags corresponding to the character count 422, the packaging information 412, the flavor information 416, and/or the set of product descriptors 418. The example program 708 of FIG. 8 then ends.

FIG. 9 is representative of example machine readable instructions 710 which may be executed to implement the example product categorizer 114 (FIGS. 1 and 5) to assign a category to a purchased product associated with a transaction record 101 (FIG. 1) received from the transaction processor 100 (FIG. 1) and standardized by the input parser 110 (FIGS. 1 and 4). Initially, at block 902, the example confidence calculator 500 determines whether it receives and/or otherwise retrieves the standardized input data 420 (FIG. 4) from the input parser 110. If the example confidence calculator 500 receives and/or otherwise retrieves the standardized input data 420, program control proceeds to block 904. At block 904, the example confidence calculator 500 selects a candidate category from a set of categories of interest based on the categories (e.g., the categories 202 of FIG. 2) in the category database 118 (FIG. 1). The set of categories of interest may be a set of all the categories in the category database 118 or a subset of the categories in the category database 118. In some examples, the subset of categories may be formed by using a selection criteria (e.g., categories related to clothes, categories related to food, categories related to children, etc.). At block 906, the example confidence calculator selects a descriptor from the set of product descriptors 418, which were retained from the raw input data 408 and stared in the standardized input data 420. At block 908, the confidence calculator 500 determines if the category selected at block 904 is associated with the descriptor selected at block 906 in the category database 118. If the category selected at block 904 is associated with the descriptor selected at block 906, program control proceeds to block 910. Otherwise, program control proceeds to block 912.

At block 910, the example confidence calculator 500 retrieves the name list weighted value (e.g., the name list weighted value 212 of FIG. 2) and the item weighted value (e.g., the item weighted value 214 of FIG. 2) associated with the selected category and the selected descriptor from the category database 118. At block 912, the example confidence calculator 500 determines if there is another descriptor in the set of product descriptors 418. If there is another descriptor, program control returns to block 906. Program control iterates through blocks 908 and 912 until all the descriptors in the set of product descriptors 418 are compared to determine if the descriptor is associated with the category selected at block 904. If there is not another available descriptor, program control proceeds to block 914. At block 914, the example confidence calculator calculates a confidence level for the category selected at block 904 using the name list weighted value(s) and the item weighted value(s) retrieved at block 910. In some examples, the confidence calculator 500 calculates the confidence level in accordance with Equation (3), Equation (4) and/or Equation (5).

At block 916, the confidence calculator 500 determines if there is another category in the set of categories of interest. If there is another category, program control returns to block 906. Program control iterates through blocks 908 and 912 until a confidence level is calculated for all the categories in the set of categories of interest. If there is not another category, program control proceeds to block 918. At block 918, the category selector 502 selects a category from the categories for which a confidence level was generated at block 914 and generates a category assignment 104 (FIG. 1). In some examples, the category selector 502 selects the category with the highest confidence level calculated at block 914 as the category assignment 104 for the product of interest. The example program 900 then ends.

FIG. 10 is representative of example machine readable instructions 1000 which may be executed to implement the example SKU prediction generator 114 (FIGS. 1 and 6) to predict an SKU for a purchased product associated with a transaction record 101 (FIG. 1) received from a transaction processor 100 (FIG. 1). Initially, at block 1002, the brand matcher 600 (FIG. 6) determines whether it receives and/or otherwise retrieves the standardized input data 420 (FIG. 4) from the input parser 110 (FIGS. 1 and 4). If the brand matcher 600 (FIG. 6) receives and/or otherwise retrieves the standardized input data 420, program control advances to block 1004. At block 1004, the example brand matcher determines whether a descriptor in the set of product descriptors 418 (FIG. 4) in the standardized input data 420 matches a brand on a brand list 606. If a descriptor in the set of product descriptors 418 matches a brand name on the brand list 606, program control proceeds to block 1006. If a descriptor in the set of product descriptors 418 does not match a brand name on the brand list 606, program control proceeds to block 1008.

At block 1006, the example description matcher 602 (FIG. 6) retrieves SKU(s) (e.g., the SKUs 302 of FIG. 3) from the SKU database 120 (FIG. 1) that have (1) the brand matched at block 1004 and (2) a category (e.g. the category 202 of FIG. 3) that matches the category assignment 104 (FIG. 1) created by the product categorizer 112 (FIGS. 1 and 5). At block 1008, the example description matcher 602 (FIG. 6) retrieves SKU(s) from the SKU database 120 that have a category that matches the category assignment 104. At block 1010, the example description matcher 602 calculates a match percentage (M %) in accordance with Equation (6).

$$M \% = \frac{\vert S ⋂ P \vert}{\vert S \vert} * 100 \% \qquad Equation ( 6 )$$

In Equation (6), S is the set of SKU descriptors 308 (FIG. 3) associated with the SKU(s) retrieved at block 1006 or block 1008, and P is the set of product descriptors 418.

For example, a product of interest may have the following set of product descriptors (P): {diaper, soft cotton, premium, new}. A first SKU may be associated with a set of SKU descriptors (S1) comprising {diaper, soft cotton, premium, super dry, flexible}. In this example, the match percentage for the first SKU would be 60% (⅗×100%=60%). A second SKU may be associated with a set of SKU descriptors (S2) comprising {diaper, soft cotton, premium, new, colorful, flexible}. In this example, the match percentage for the second SKU would be 67% ( 4/6×100%=67%).

At block 1012, the description matcher 602 determines whether one or more of the SKU(s) 302 with the highest match percentage calculated at block 1010 (e.g., candidate SKU(s)), have packaging information (e.g., the packaging information 310 of FIG. 3) that matches the packaging information 412 (FIG. 4) of the standardized input data 420. If the packaging information 310 associated with the selected SKU(s) matches the packaging information 412 in the standardized input data 420, program control advances to block 1014. Otherwise, program control advances to block 1016, at which the example SKU predictor 604 assigns a SKU prediction 106 using a candidate SKU (e.g., the SKU 302 with the highest match percentage calculated at block 1010). The example program 1000 then ends. At block 1014, the example SKU predictor 604 (FIG. 6) assigns an SKU prediction 106 (FIG. 1) based on a candidate SKU with the packaging information 310 that matches the packaging information 412 of the standardized input data 420. The example program 1000 then ends.

FIG. 11 is representative of example machine readable instructions 1100 which may be executed to implement the example SKU prediction generator 114 of FIGS. 1 and 6 to assign an assurance level to the SKU prediction 106 (FIG. 1). Initially, at block 1102, the SKU predictor 604 (FIG. 6) determines if the packaging information (e.g., the packaging information 310 of FIG. 3) associated with the predicted SKU (e.g., the SKU predicted by example program 1000 of FIG. 10) matches the packaging information 412 (FIG. 4) in the standardized input data 420. If so, program control advances to block 1104. Otherwise, program control proceeds to block 1106. At block 1104, the example SKU predictor 604 determines whether the match percentage between the SKU descriptors 310 (FIG. 3) and the set of product descriptors 412 (FIG. 4) (e.g., the match percentage calculated at block 1010 of FIG. 10) is greater than a threshold value defined by the RME 102 (FIG. 1). If the percentage match is greater than the threshold value, program control advances to block 1108. If the percentage match is not greater than the threshold, program control advances to block 1110. At block 1106, the SKU prediction 106 is assigned a third assurance level. The example program 1100 of FIG. 11 then ends. At block 1108, the SKU prediction 106 is assigned a first assurance level. The example program 1100 of FIG. 11 then ends. At block 1110, the SKU prediction 106 is assigned a second assurance level. The example program 1100 of FIG. 11 then ends.

FIG. 12 is a block diagram of an example processor platform 1000 capable of executing the instructions of FIGS. 7-10, and/or 11 to implement the input parser 110, the product categorizer 112, and/or the SKU prediction generator 114 of FIGS. 1, 4, 5 and/or 6. The processor platform 1200 can be, for example, a server, a personal computer, a workstation, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1224 are also connected to the interface circuit 1220 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1220 of the illustrated example, thus, typically includes a graphics driver card, a graphics driver chip or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives.

The coded instructions 1232 of FIGS. 7-11 may be stored in the mass storage device 1228, in the volatile memory 1214, in the non-volatile memory 1216, and/or on a removable tangible computer readable storage medium such as a CD or DVD.

From the foregoing, it will be appreciated that examples have been disclosed which allow products to be identified even when indexable identifiers are not associated with the product. Additionally, examples have been disclosed which allow a research measurement entity to process transaction records related to a large volume of transactions involved with e-commerce websites.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The status of the claims:

1. A method to assign a product to a category, comprising:
converting a natural language product description associated with a transaction record that does not include indexable identifiers to create input data comprising product descriptors;
generating a first confidence level associated with a first candidate category based on ones of the product descriptors having a first weighted value associated with the first candidate category;
generating a second confidence level associated with a second candidate category based on ones of the product descriptors having a second weighted value associated with the second candidate category; and
assigning the product to one of the first or second candidate categories based on a difference between the first and second confidence levels.

2. A method as defined in claim 1, wherein the first and second weighted values are at least one of an item weighted score and a namelist weighted score.

3. A method as defined in claim 1, wherein assigning the product to one of the first or the second category comprises assigning the product based on the greater of the first confidence level and the second confidence level.

4. A method as defined in claim 1, further comprising:
assigning a stock keeping unit prediction to the product.

5. A method as defined in claim 4, wherein the stock keeping unit prediction is based on the assigned one of the first or second candidate categories.

6. A method as defined in claim 4, further comprising:
assigning an assurance level to the stock keeping unit prediction.

7. A method as defined in claim 1, wherein converting natural language product description associated with the transaction record that does not include indexable identifiers to create input data comprises:
identifying packaging information included in the natural language product description; and
identifying product descriptors included in the natural language product description.

8. A tangible computer readable storage medium comprising instructions which, when executed, cause a machine to at least:
convert a natural language product description associated with a transaction record that does not include indexable identifiers to product descriptors;
associate a first confidence level with a first candidate category based on ones of the product descriptors having a first weighted value associated with the first candidate category;
associate a second confidence level with a second candidate category based on ones of the product descriptors having a second weighted value associated with the second candidate category; and
assign the product to one of the first candidate category or second candidate category based on a difference between the first and second confidence levels.

9. A tangible computer readable storage medium as defined in claim 8, wherein the first and second weighted values are at least one of an item weighted score and a namelist weighted score.

10. A tangible computer readable storage medium as defined in claim 8, wherein the instructions further cause the machine to at least:
assign a stock keeping unit prediction to the product.

11. A tangible computer readable storage medium as defined in claim 10, wherein the instructions cause the machine to assign the stock keeping unit prediction by calculating a first match percentage for a first candidate stock keeping unit, calculating a second match percentage for a second candidate stock keeping unit, and selecting the first or second candidate stock keeping unit based on a highest of the first and second match percentages.

12. A tangible computer readable storage medium as defined in claim 11, wherein the instructions cause the machine to calculate the first match percentage by comparing a first set of stop keeping unit descriptors associated with a first candidate stock keeping unit with the product descriptors, and to calculate the second match percentage by comparing a second set of stop keeping unit descriptors associated with a second candidate stock keeping unit with the product descriptors.

13. A tangible computer readable storage medium as defined in claim 10, wherein the instructions further cause the machine to at least:
assign an assurance level to the stock keeping unit prediction.

14. A tangible computer readable storage medium as defined in claim 8, wherein instructions to convert a natural language product description associated with a transaction record that does not include indexable identifiers to product descriptors comprises instructions to further cause the machine to at least:
identify packaging information included in the natural language product description; and
identify product descriptors included in the natural language product description.

15. A tangible computer readable storage medium as defined in claim 8, wherein the instructions cause the machine to calculate the first weighted value by summing descriptor weighted values associated with the first category corresponding to the product descriptors, and to calculate the second weighted value is calculated by summing descriptor weighted values associated with the second category corresponding to the product descriptors.

16. An apparatus to assign a product to a category comprising:
an input parser to convert a nature language product description associated with the product into product descriptors and packaging information; and
a product categorizer to assign a first confidence level to a first candidate category based on ones of the product descriptors having (1) a first weighted value and being (2) associated with the first candidate category, and to assign a second confidence level associated with a second candidate category based on the ones of the product descriptors having (1) a second weighted value and being (2) associated with the second candidate category, the product categorizer to assign the product one of the first candidate category or the second candidate category based on the first and second confidence levels.

17. The apparatus of claim 16, further comprising:
a stock keeping unit prediction generator to assign a stock keeping unit prediction to the product based on the category assigned by the product categorizer.

18. The apparatus of claim 17, wherein the stock keeping unit prediction generator is to assign an assurance level to the stock keeping unit prediction.

19. The apparatus of claim 16, wherein the input parser comprises:
a character counter to count a number of characters in the natural language product description;
an information retriever to retrieve packaging information from the natural language product description;
a data cleaner to remove function characters from the natural language product description; and
a descriptor retriever to retrieve product descriptors from the natural language product description and to generate the standardized input data.

20. The apparatus of claim 16, where the product categorizer is to calculate the first weighted value by summing descriptor weighted values associated with the first category corresponding to the product descriptors, and the product categorizer is to calculate the second weighted value by summing descriptor weighted values associated with the second category corresponding to the product descriptors

21-27. (canceled)
